(19) United States
(12) Patent Application Publication
(10) Pub. No.: US 2007/0021095 A1
(43) Pub. Date: Jan. 25, 2007

(54) Apparatus and method for local broadcasting in the twenty-six megahertz short wave band

(75) Inventors: Po-Shin Cheng, Fremont, CA (US); Gordon G. Sinclair, Mountain View, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: TCI International, Inc.

(21) Appl. No.: 11/490,249

(22) Filed: Jul. 21, 2006

Related U.S. Application Data
(60) Provisional application No. 60/701,511, filed on Jul. 22, 2005.

(51) Int. Cl. H04Q 7/20

(52) U.S. Cl. 455/403

(57) ABSTRACT

A short wave omnidirectional antenna for the 26 Megahertz band provides line-of-sight broadcasting at comparatively low power to serve local communities while suppressing sky wave propagation. Sky wave suppression is achieved by a critically configured reflector above the radiator or by a co-located second active or parasitic radiator spaced to achieve sufficient beam tilt to create a null at critical angles, generally from the horizon to thirty degrees above. This arrangement allows local broadcasts to be originated at numerous sites despite the narrow extent of the band (330 kHz) and the narrow (10 kHz) channel width. Among other possible applications, the antenna supports transmission using the Digital Radio Mondiale® (DRM®) system for COFDM. COFDM technology can suppress ghosting and most noise, while low emission angle of the antenna and low intended transmitter power largely prevent interference between broadcasts at moderate distances.

### CLAIM OF PRIORITY

This application claims priority to U.S. Provisional Application entitled, “Description of Antenna for Transmitting Short Wave Signals in the 26 MHz Band”, filed Jul. 22, 2005, having Ser. No. 60/701,511, which is hereby incorporated by reference in its entirety.

### FIELD OF THE INVENTION

The present invention relates generally to radio frequency electromagnetic signal (RF) broadcasting. More particularly, the present invention relates to techniques for broadcasting electromagnetic signals in the 26 MHz Short Wave band with sky wave suppression.

### BACKGROUND OF THE INVENTION

There is a trend toward adoption of digital technology in radio and communications, especially for distribution and transmission. Digitization offers substantial advantages to national and international broadcasters in the short wave bands from 2 to 30 MHz. Analog transmissions are often of poor quality because of fading and interference from both human-made and natural sources.

The Digital Radio Mondiale (“DRM®”) consortium has developed a world-recognized standard for a digital modulation of short wave transmissions that can produce signals of “FM” quality—that is, signals comparable to frequency-modulated analog signals in the familiar VHF entertainment broadcasting band at 88 MHz to 108 MHz, hereinafter the FM band—in their resistance to variations in signal level due to ghosting and other forms of interference and in their resistance to extraneous noise from electrical sparks, lightning, and other sources. While it is to be understood that the FM band is also undergoing digital enhancement, the perceived quality of performance of FM since its inception remains a standard of excellence. Except as noted, the electrical engineering (EE) term of art “RF” is used herein in its usual senses—that is, to refer either to radio frequency (broadly, subsonic to terahertz) electromagnetic signals or to the frequencies of the signals, as implied by the context. Other EE terms of art are likewise used in their usual senses except as noted.

Short wave broadcasting typically directs a signal toward the ionosphere, which, by reflecting and/or refracting the signal, and generating a so-called sky wave, allows the signal to reach audience areas many hundreds or thousands of kilometers from the transmitting station. To achieve reception at these distant targets, transmitter power typically has to be 50 kilowatts (kW) or higher, with many short wave transmitters providing output power of 250 kW to 500 kW.

At the upper end of the short wave band, as at substantially all other frequencies, broadcast signals can propagate directly to receivers in the line of sight, and, if a transmitting antenna is mounted on a suitably tall structure, can be received at distances on the order of 60 miles (100 km) from the antenna. Line of sight transmission, also termed transmission by terrestrial wave herein in contradistinction to transmission by sky wave, can use both familiar analog and DRM® and other, equivalent digital modulation methods, with the digital methods allowing signals to be received with very high quality. Such signal quality, comparable to that of FM band broadcasting, can be achieved while using only relatively low broadcast power, namely, a hundred watts to a few thousand watts. Unlike VHF-FM broadcasting, DRM® and other digital transmission methods have been developed for operation at frequencies ranging from approximately 200 kHz to 30 MHz. Of relevance for the instant invention is the upper short wave band from 25.67 MHz to 26.10 MHz, hereinafter the 26 MHz band, currently little used.

While legacy (primarily non-digital) operators within this narrow 330 kHz-wide band have been assigned 9 kHz- or 10 kHz-wide channels, and have been allowed very wide but irregular (time-of-day and sunspot-cycle dependent) geographic coverage with high-power amplitude-modulated (AM) and/or sideband amplifiers, digital operators propose to provide direct local coverage, such as with COFDM (coded orthogonal frequency division multiplexed) signals—digital signals using data blocks transmitted simultaneously at multiple, narrowly-spaced frequencies according to a highly robust scheme. Suitable modulators form the signals according to at least one published standard (refer to ETSI ES 201 980, latest edition, for encoding algorithms), while conventional and more advanced transmitters can broadcast the signals. Depending on the level of fidelity, resistance to loss, and extra features desired, channels as narrow as 2 kHz or as wide as 32 kHz can be used for digital transmissions. Cobroadcasting of conventional analog signals can allow both digital and conventional radios to pick up programs on the same channel, albeit with differences in quality and features.

The availability of line-of-sight broadcasting in the 26 MHz band potentially enables broadcasters to provide largely local coverage from numerous short-range transmitters. In the major cities of most developed countries, the channels of the FM band are effectively all allocated. In the present era, a broadcaster who desires to establish a new service has had to purchase an allocation from another broadcaster, often at enormous expense. However, since the 26 MHz short wave band is lightly used at present, there exists potential for many new stations to supply local broadcast services, if sky wave propagation can be suppressed.

Unlike an FM-band signal, propagation of which is largely limited to line of sight, a short wave 26 MHz transmission can also propagate by sky wave, and, under certain ionospheric conditions, can produce a strong signal at great distances from the transmitting antenna. For this reason, a 26 MHz short wave antenna intended to broadcast strictly locally must emit a signal that is reduced in strength at those angles that would allow the signal to propagate long distances.

What is needed is a short wave antenna that minimizes the tower space needed for structural support and that, in the same design, minimizes undesirable sky wave propagation.

### SUMMARY OF THE INVENTION

The foregoing needs are met, to a great extent, by the present invention, wherein an apparatus is provided that in some embodiments provides a short wave broadcast antenna that suppresses sky wave emission while providing gain for low-elevation signals, further providing power handling capability suitable for line-of-sight broadcasting service from ground-mounted transmitting towers.

In accordance with one embodiment of the present invention, a sky wave suppressing broadcast antenna system for short wave radio frequency electromagnetic (RF) signals is presented. The antenna includes a first radiator, configured to emit an RF signal with substantially omnidirectional distribution of energy with respect to azimuth, and a signal directing apparatus configured to direct energy from the first radiator, wherein the energy directed by the signal directing apparatus is energy that would support ionospheric reflective/refractive propagation, wherein the directed energy is so directed as to reinforce line-of-sight propagation.

The above antenna embodiment further includes a reflector positioned further from a mean terrain surface than the first radiator, wherein the substantially cone-shaped reflector surface is formed from a plurality of reflector components.

Another antenna embodiment includes instead a second radiator, configured to couple and reradiate RF energy emitted by the first radiator, wherein RF emission from the second radiator destructively interferes with RF emission from the first radiator in a sky wave direction and constructively interferes with RF emission from the first radiator in a terrestrial wave direction.

In accordance with still another embodiment of the present invention, a sky wave suppressing broadcast antenna system for short wave radio frequency electromagnetic (RF) signals is presented. The antenna includes first means for radiating, configured to emit an RF signal with substantially omnidirectional distribution of energy with respect to azimuth, means for mechanically positioning the first means for radiating in an elevated location, and means for directing signals, configured to direct energy from the first means for radiating, wherein the energy directed by the means for directing signals is energy that would support ionospheric reflective/refractive propagation, wherein the directed energy is so directed as to reinforce line-of-sight propagation below a horizon line as determined with respect to the first means for radiating.

In accordance with yet another embodiment of the present invention, a method for broadcasting short wave radio frequency electromagnetic (RF) signals is presented. The method includes the steps of providing on a broadcast tower a mounting point for an RF signal radiator, wherein the mounting point has sufficient height above mean terrain to permit line-of-sight transmission of high-band short wave RF signals over a specified area, emitting a vertically-polarized RF signal from a first radiator having broadly omnidirectional distribution of energy with respect to azimuth, wherein the first radiator is affixed to the broadcast tower mounting point, and directing the RF signal energy both to suppress sky wave propagation and to reinforce line-of-sight propagation over the specified area.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. It is also to be understood that the phraseology and terminology employed herein, as well as the abstract, are for the purpose of description, and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side elevation view of a section of a broadcast tower bearing a single-bay multiple-radiator omnidirectional antenna according to one embodiment of the prior art.

FIG. 2 is a top view of the antenna of FIG. 1.

FIG. 3 is a chart plotting signal strength in dBi versus elevation angle for the antenna of FIG. 1.

FIG. 4 is a side elevation view of a section of a broadcast tower bearing a single-bay multiple radiator omnidirectional antenna according to one embodiment of the instant invention.

FIG. 5 is a top view of the antenna of FIG. 4.

FIG. 6 is a top view of the antenna of FIG. 4 having a second reflector embodiment.

FIG. 7 is a top view of the antenna of FIG. 4 having a third reflector embodiment.

FIG. 8 is a chart plotting signal strength in dBi versus elevation angle for an antenna according to FIG. 4.

FIG. 9 is a side elevation view of a section of a broadcast tower bearing a two-bay multiple radiator omnidirectional antenna according to a second embodiment of the instant invention, wherein both bays are driven.

FIG. 10 is a side elevation view of a section of a broadcast tower bearing a two-bay omnidirectional antenna according to a third embodiment of the instant invention, wherein the lower bay is parasitic.

FIG. 11 is a chart plotting signal strength in dBi versus azimuth for an antenna according to FIG. 10.

FIG. 12 is a chart plotting signal strength in dBi versus elevation for an antenna according to FIG. 10.

### DETAILED DESCRIPTION OF PREFERRED EMBODIMENTS OF THE INVENTION

The invention will now be described with reference to the drawing figures, in which like reference numerals refer to like parts throughout. The present invention provides an apparatus and method that in some embodiments provides an antenna that suppresses sky wave emission while broadcasting short wave signals by line of sight.

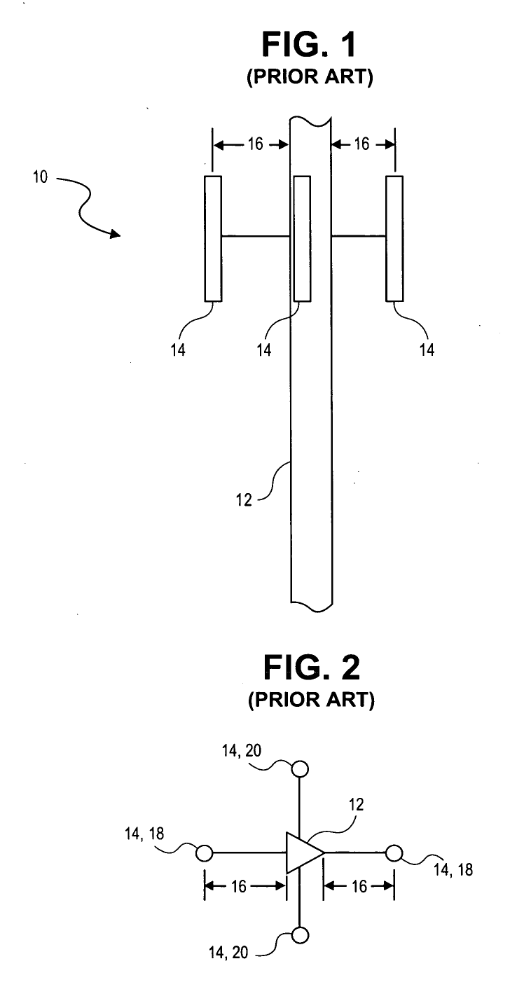

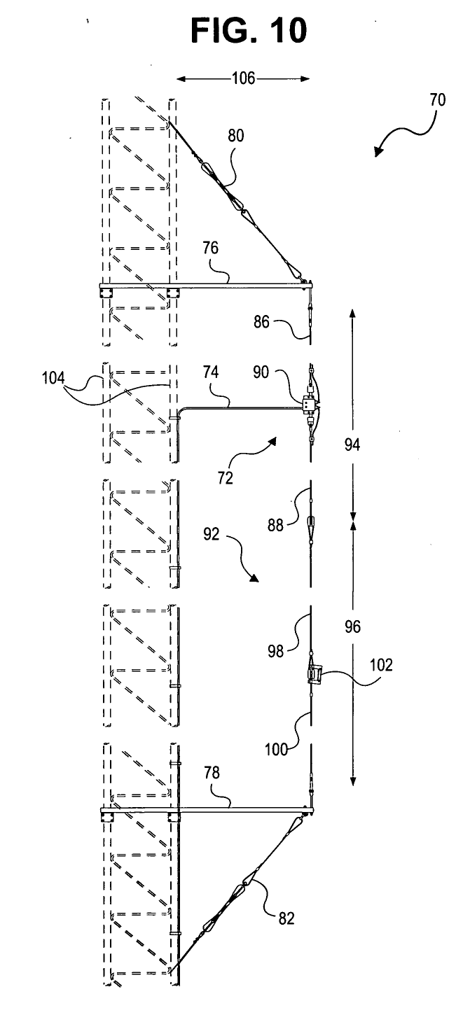

FIG. 1 shows a typical structural arrangement for an antenna 10 and mast section 12, wherein the antenna 10 is intended to broadcast substantially uniformly in all azimuth directions. In the 26 MHz operating band, the size of the radiators in an antenna system is approximately four times as large in every dimension as those in a comparable FM band (VHF) antenna system. While generic radiating elements (which could be dipoles, reflector-backed panel radiators, or the like) are shown in the majority of the figures herein, it is to be understood that any type of radiator suitable for positioning with respect to a tower and for operating at a power level appropriate for broadcasting may be used in a specific application, and indeed FIG. 10 will show a specific embodiment fully suited for manufacture and use.

For illustration purposes, a single bay arrangement without sky wave suppression is considered first. With four radiating elements 14, all driven in phase, such an antenna 10 produces a vertically-polarized signal with a radiation pattern in the horizontal plane that is substantially omnidirectional with azimuth, and the influence of the triangular, open-structure conductive mast 12 may be largely neglected. Mast 12 shape, the number and type of radiating elements 14, the distance 16 from the mast 12 to the respective elements 14, as well as embodiment options such as phasing excitation of the elements 14 at 90 degree intervals rather than in phase, affect azimuth uniformity and other characteristics of the antenna 10, but are substantially independent of the inventive characteristic of the instant invention. If the number of radiators 14 is reduced to three (uniformly distributed), a generally omnidirectional characteristic can be maintained, albeit with reduced azimuth uniformity; it is generally understood in the art that an antenna 10 having only two radiators 14 per bay may produce excessive nulls in at least some embodiments, in which case it is no longer seen as omnidirectional. An antenna 10 having a single radiator 14 mounted alongside the mast can achieve a propagation pattern that may be acceptable for at least some applications, provided the relative null where the mast 12 shadows the radiator 14 can be tolerated. For some applications, such a null may be useful, such as to transmit to a nonsymmetrical population area, to transmit from an edge of a town, to avoid interference with a nearby transmitter, and the like.

FIG. 2 shows the antenna 10 of FIG. 1, wherein antenna elements 14 and mast 12 are viewed from above. In this embodiment, the elements 14 are four uniformly-displaced dipoles driven in phase. Dipole spacing 16 from the mast 12 is less than a half wavelength, so each dipole radiates in a substantially cardioid pattern, each opposite-side pair 18 and 20, respectively, has a generally “peanut” pattern, and the crossed peanuts form an omnidirectional pattern to a good approximation.

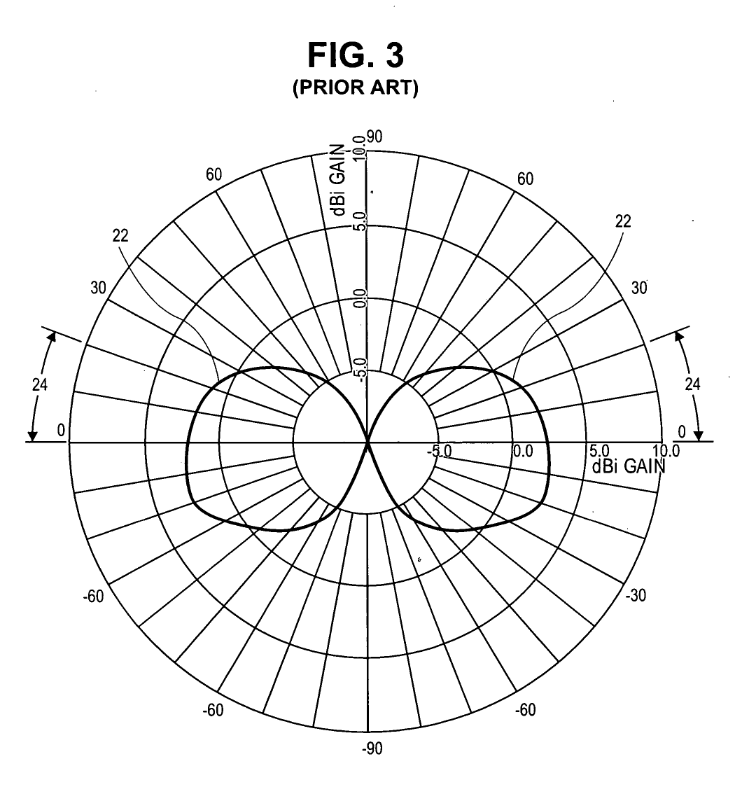

FIG. 3 depicts the radiation pattern 22 of the antenna of FIG. 1 in a representative elevation plane, showing that very strong radiation exists between the horizon and a twenty degree positive elevation angle 24 as well as below the horizon. The radiated energy within the zero-to-plus-twenty-degree range of elevation angles in the proposed operating band at 26 MHz has the potential to propagate for great distances through a combination of reflection and refraction by the layers of the ionosphere, as regulated by time of day and the influence of the eleven-year sunspot cycle, and thus introduces a potential for unwanted interference with other short-range broadcasts operating on nearby channels within the 26 MHz band in distant locations.

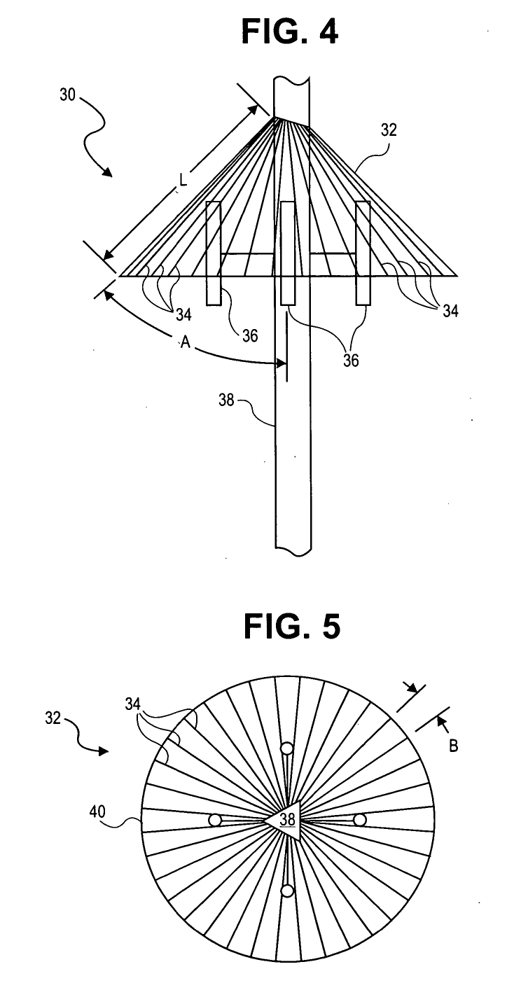

FIG. 4 shows a remedy for this defect, namely the addition to the antenna 30 of a reflecting screen or reflector 32, which may have the form of a set of down-sloping radial wires 34. This reflector 32 can be configured to redirect a portion up to substantially all skyward-propagating radiated energy to a direction below the horizon. The redirected energy can be caused to add with the directly-radiated below-the-horizon energy to a good approximation, thereby providing gain within the line-of-sight range while greatly attenuating the sky wave. The length L (effectively the surface half-length of the complete reflector) and the horizon-referred slope angle A of the wires 34 making up the reflector 32 can be gauged with respect to the dimensions of the radiating elements 36. The reflector 26 dimensions—length, angle, number, and diameter of wires 34, as well as the position of the reflector 32 with respect to the radiating elements 36—constitute design parameters that determine the radiation pattern in the elevation plane to a significant extent. The range of wire length L and slope angle A that can be shown to be effective in providing desired redirection of the sky wave can be shown to include at least:

Length: 0.66 wavelengths to 1.0 wavelength

Angle: 30 degrees to 60 degrees below horizon

FIG. 5 shows the antenna of FIG. 4 as viewed from above. The number of wires 34 used in the reflector 32 affects performance; this may vary depending upon diameter, length, and slope angle A of each wire 34, and establishes a radial angular spacing B therebetween. In the embodiment shown, there are 36 wires spaced at 10 degree intervals. Each wire has a 0.2 inch (5 mm) diameter. Other wire diameters and angular spacings may be preferred for specific embodiments, and may likewise achieve a specified level of operational performance.

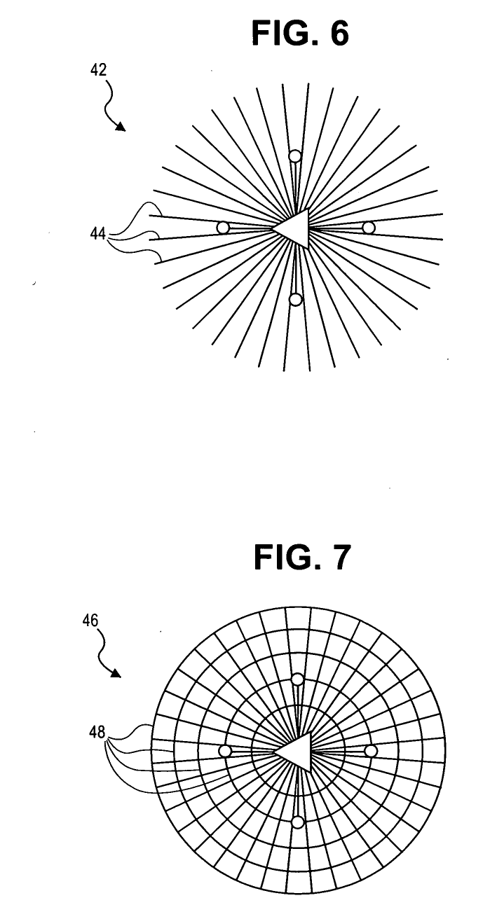

The embodiment of FIGS. 4 and 5 shows a reflector 32 made up of conductors 34 connected together at the tower 38 end and also joined by a conductive ring 40 distal to the tower 38 to form an approximate wheel shape. In other embodiments, the conductors may be interconnected mechanically using a ring 40 that is nonconductive, or, as shown in FIG. 6, may form a reflector 42 wherein the individual wires 44 are free floating. As shown in FIG. 7, a “spider web” shape 46 may be formed using a plurality of (conductive or nonconductive) linkages 48 between the conductors of the reflector 46.

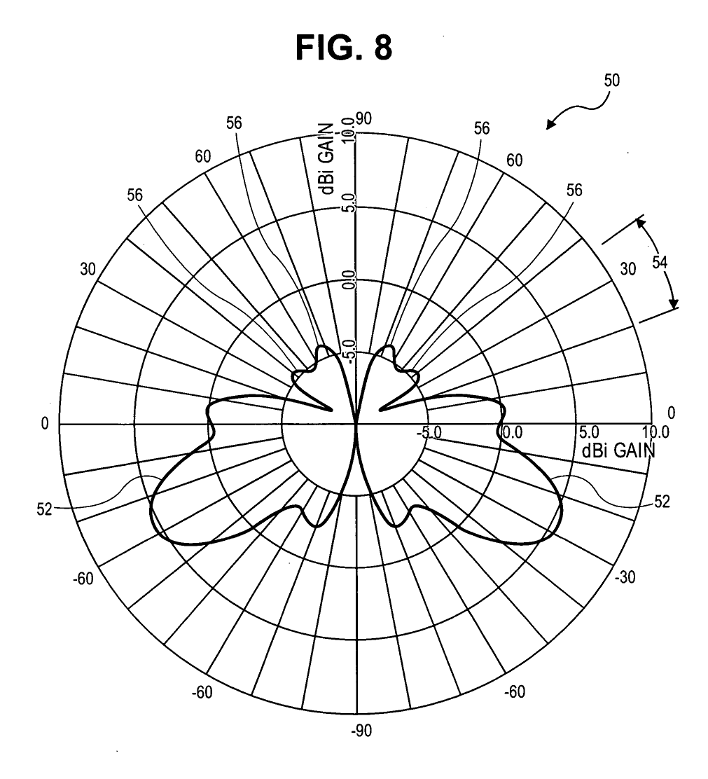

FIG. 8 shows a typical radiation pattern 50 in the elevation plane that can be achieved with the instant invention. The downward-directed lobes 52 provide line-of-sight signals from essentially the base of the antenna to the horizon, using direct energy from the radiators 36 reinforced by energy from the reflector 32 shown in FIG. 4. The signal energy from about −3 degrees up to the zenith is down at least 5 dB in this embodiment, and at least 10 dB from 20 degrees to 36 degrees 54, with minor lobes 56 centered roughly at 40 degrees and 67 degrees. Since energy at the angles of incidence of the minor lobes 56 cannot in general be redirected in the ionosphere, the overall radiation pattern shown in FIG. 8 is substantially optimized for local broadcast.

In configuring the antenna 30 embodiment shown in FIGS. 4 through 8 using conventional “method of moments” antenna design software, a horizontal, planar, grounded shield can be demonstrated as a starting point for development of the reflector 32. Such a planar shield, whether solid or in the form of wires or grid similar to the shields shown in FIGS. 5, 6, and 7, provides appreciable improvement over the antenna of FIG. 1, but leaves substantial energy directed toward the reflection/refraction zone for any practical (less than infinite) size of ground plane. Reshaping the shield from a plane into a cone can be shown to improve antenna performance, both in increasing gain and in directly suppressing the sky wave.

Near-optimum solutions for angle and diameter can be identified by fairly rapid cut-and-try development, such as by using a wavelength of the center frequency as a first estimate of wire length and selecting a few slope angles between 30 degrees and 60 degrees below the horizon for analysis. Varying wire length L and angle A will indicate trends. Reflector 32 mounting provisions may be developed readily in view of a specific mast cross section and surface arrangement. For particular radiator designs, reflector mounting height with respect to the radiators may require further stepwise analysis. The process may point toward a single optimal solution or may point to families or classes of solutions, wherein each length L of reflector, for example, may have an optimum angle A and position with regard to the achieved combination of signal strength near the horizon and attenuation of the sky wave.

Similarly, shield reflectivity is a function of coverage, with a single solid conductor being most effective, but typically heavy and susceptible to wind loading, while sparse or thin wires become increasingly RF transparent and ultimately fragile in the presence of wind, birds, ice, and the like. Woven mesh, pierced or expanded metal, metal-clad fiber-reinforced plastics, or the like may be an effective reflective component in some applications. Refinement to a final product involves trading off material cost and manufacturability, durability, RF performance, installation considerations, and other issues.

It is to be understood that a reflector 32 added to an existing antenna 10 (FIG. 1), wherein the antenna 10 may have low gain and/or omnidirectional propagation, for example, may provide performance approaching that of a new-built radiator and reflector combination, provided the parameters are comparable. Thus, for example, an “aftermarket kit” reflector product may be suitable in some embodiments for converting an existing facility from a long range, amplitude modulated shortwave broadcaster with highly variable, ionosphere-dependent coverage to a regional/local DRM® broadcaster with stable, largely static-free coverage.

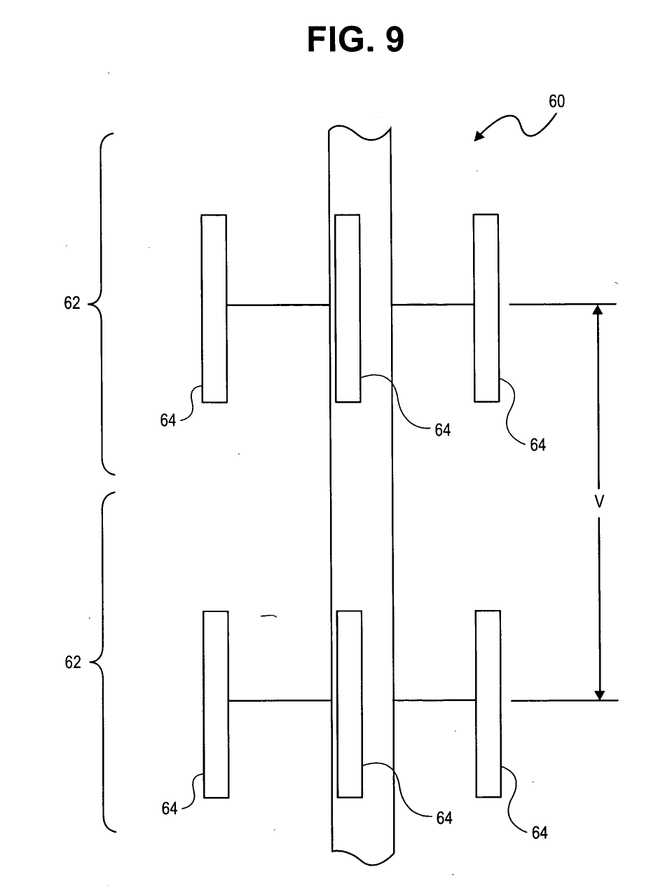

FIG. 9 depicts an alternative antenna embodiment 60 capable of providing a radiation pattern in the elevation plane approaching the pattern 50 shown in FIG. 8. The pattern 50 of FIG. 8 is broadly obtainable with at least one multiple-bay arrangement of radiating elements, provided proper phasing between the bays is provided.

It is to be understood that use of a suitably large vertical aperture—that is, a tall RF radiator, such as one composed of a capacitively-coupled monopole string or an array of dipoles—can cause the elevation radiation pattern of a short wave antenna to be narrowed to substantially any desired extent. However, in the 26 MHz band, in which the wavelength is about 38 feet (11.6 meters), such an aperture might occupy 40 feet to 160 feet (11 meters to 45 meters) or more of vertical space on a supporting tower. Since it is frequently desirable that an antenna be mounted as high as possible on a tower, for example to maximize its line-of-sight range of transmission, it may be impractical for both technical and financial reasons to provide such an aperture on an existing or newly-built tall tower.

For example, in a two-bay 62 arrangement of vertically-polarized, active radiators 64, if the bays 62 have a vertical center-to-center separation V of one wavelength and are driven in phase, then there will be strong gain in the horizontal plane, with significant energy above the horizon, potentially capable of propagating long distances as a sky wave. If beam tilt is applied—i.e., the physical spacing V is less than a wavelength for a bottom-fed array—then less of the signal will propagate upward. This antenna occupies roughly one and a half wavelengths of vertical height, nearly 60 feet (over 17 meters), without allowance for gaps above and below.

Still other configurations and larger numbers of driven radiators 64 can be used to achieve further improvement, at cost of significant increases in overall antenna size and in complexity for power splitting and interconnection. For example, in the embodiment of FIG. 9, in order to drive eight elements in two bays 62, an eight-way splitter, a two-way followed by two four-ways, a set of taps with impedance cancellation, or the like is required to provide excitation to the eight elements 64 shown, maintaining appropriate amplitude and phase. Each addition of a bay 62 adds not only height on the tower but also splitting and interconnecting apparatus, including connectors and cables, all of which have financial, wind loading, and failure rate costs. Embodiments wherein all radiators 64 in a plurality of bays 62 are driven are thus feasible but may be less than optimum, particularly for low-budget applications, in consideration of size, initial price, reliability, and the like. Replacing most of the driven elements with parasitics can be beneficial in terms of cost and reliability. The discussion below for an embodiment with a single driven dipole is also applicable to other embodiments.

It is to be understood that a typical broadcast antenna tower is a conductive and largely unitary assembly built up from multiple tubes, channels, angles, plates, and the like, variously bolted and welded together, having individual segments of varying effective length. Such a tower may have an RF profile that is not configured to be specifically compatible with a given antenna design. As a consequence, the tower may present a variety of reflections with measurable effects on propagation characteristics of the antenna. Where desired, the effect of a particular tower design on far field signal can be simulated in the “method of moments” software previously referred to, modeling the construction of the tower and computing the effect of the presence of a specific tower on overall antenna gain versus elevation for every azimuth. Such a process may yield a tower reflectivity plot having a least squares centroid of reflection not coincident with the structural centroid, that is, the center of moments of the tower structure. A reflection axis identified for the tower may provide a useful term of reference. For typical antennas, the reflection axis or reflection centroid is likely to be a minor factor in overall broadcast performance; nonetheless, it may affect operation and may need to be determined for at least some applications.

Towers may be guyed or free standing. Where guyed, the guy wires are typically configured as multiple segments joined by insulators, with the lengths of the segments typically chosen for minimal interaction with radiated signals. Modeling and test of guy wires as well as the tower structure may be desired for some embodiments.

The multiple-radiator embodiments described above may be modified by adjusting the number and location of the radiating elements located around the tower to provide a pattern that is directional in the azimuth plane. This can be useful, for example, in circumstances wherein the transmitting tower is not located in the center of the target area, so that it is desirable or necessary to minimize radiation in unwanted azimuthal directions while maximizing radiation in directions intended to be served. For example, the embodiments shown in FIGS. 4 and 9 use bays having four radiators, spaced substantially uniformly with respect to the reflection axis of a (triangular, conductive) tower and at substantially equal angles with respect to each other. As noted, the combined azimuth patterns for these configurations are largely uniform for typical embodiments, with a lobe at each radiator and slight relative nulls halfway between lobes. By applying unequal signal strength to the four radiators in each bay, the overall propagation pattern can be offset; if preferred, various emission patterns can be realized by positioning the radiators at nonuniform angular spacings around the tower. By using three (generally a minimum for approximating omnidirectionality) or fewer radiators, or by using more than four radiators, possibly in combination with power adjustments, the azimuth signal strength pattern can be further varied.

It may be helpful analytically for some embodiments to assign a vertical mechanical reference axis of the antenna system that broadly coincides with a mechanical centroid of the tower, wherein the tower is understood to provide means for structurally positioning the antenna system. In at least some instances, assignment may be made of a vertical axis that reasonably approximates a centroid of RF signal reflectivity (i.e., a locus of mean squared reflectivity) of the tower, by azimuth, for impinging RF signals, where an applied signal wavelength approximates a median transmission wavelength of the antenna. Further, each impingement angle may be stipulated with respect to a line through the structural reference axis of the antenna system, with the centroid of reflection having been established by calculation, test, or product history. If an embodiment requires that distribution of RF signal energy emitted by the antenna system differ from being omnidirectional with azimuth, then the reference system described allows models to be developed for analysis of effects due to varying the placement of multiple radiators, varying applied power to individual radiators, and varying phase of the signal applied to each radiator. Such a process can realize a particular energy distribution with respect to the reference system, such as by modifying a system and analyzing the effect of such modification. Values such as the centroid may be developed by analysis, by testing on prototypes or production units, by accumulated data from history of multiple products, and the like.

FIG. 10 is an embodiment having performance comparable to that of the embodiments shown in FIGS. 4 and 9, but drastically simpler in configuration than the antenna of FIG. 9, and trading off aperture height, material cost, and complexity against some performance limitations when compared to the antenna of FIG. 4. This antenna 70 has a single upper dipole 72 that is center fed, a coaxial feed line 74, support brackets 76 and 78, and tensioning cables 80 and 82. The upper monopole 86 and lower monopole 88 of the upper dipole 72 are driven with broadcast signals through the coax 74 from their respective proximal points using a balun 90 in the embodiment shown; a balanced feed such as a shielded pair or another style of unbalanced-line-to-balanced-line transformer can provide matching in other embodiments. The lower dipole 92 is parasitic, that is, undriven, and is mounted approximately tip-to-tip with the upper dipole 72. Because the lower dipole 92 is excited by signals propagating from the upper dipole 72, the two bays 94 and 96 can be configured to achieve downward beam tilt by spacing them further apart than the nominal spacing, rather than closer together. The upper 98 and lower 100 component monopoles of the lower dipole 92 can be coupled with a suitable coupling device 102, which may be a capacitor in some embodiments.

Dipoles 72 and 92 in respective bays 94 and 96 are each roughly a half wavelength in physical length. Because the lower bay 96 is close to the upper, with just over a half wavelength between centers, the lower dipole 92 has reverse phase with respect to the upper dipole 72. By analysis and test, it can be shown that the lower dipole 92 can have instantaneous radiative signal strength on the order of 80% of that of the upper dipole 72 for some embodiments. For an optimized spacing P between the bays 94 and 96, again developed using the abovementioned “method of moments” antenna design software, then validated by prototype testing, a null can be developed in the range of +10 degrees to +30 degrees with respect to the horizon, which is the range most likely to be reflected and/or refracted to form a sky wave. This can leave a lobe roughly 10 dB below the main lobe, tilted up to about +45 degrees, which is generally not susceptible to ionospheric redirection and thus may represent an acceptable radiative energy loss without causing appreciable interference to distant radio services.

The two-bay embodiment of FIG. 10 may realize reduction in sky wave emission comparable to that of the ground-plane-topped embodiment of FIG. 4. While the aperture for the two-bay structure 70 occupies an appreciably larger amount of possibly valuable tower space than the embodiment shown in FIG. 4, either embodiment may be preferred for a specific application. Specific tradeoffs in selecting between the embodiments may include overall apparatus mass (and moment) including icing, available aperture space, effective wind load, mechanical resonant frequency, radiative interaction with tower shape and other antennas on the tower, and the like.

Extension beyond the two-bay embodiment shown using more parasitic radiators, such as a third bay, is feasible, and may provide further refinement of beam shape in exchange for increased material cost and tower space. Positioning the active and parasitic bays a full wavelength apart (plus the beam tilt dimension) has both benefits, such as somewhat increased gain, and drawbacks, such as substantially the same increase in tower space as adding a third dipole. In some such embodiments, the two dipoles may be in phase rather than having opposite phase. Placing the active dipole 72 below the parasitic 92 produces slight variations in performance. As noted, interbay spacing with the active dipole 72 below must be slightly less than an integer number of half wavelengths instead of slightly greater. This may in turn require adjustment to dipole length and termination, affecting efficiency.

The embodiment of FIG. 10 is relatively simple albeit asymmetrical. Low weight is traded off against mechanical stress imbalance, and may be compensated at least in part with reinforced structure, such as larger horizontal spacing between the tower 104 verticals, a compensating (non-radiating) tension structure opposite the antenna (not shown, but substantially mirroring the antenna 70 in arrangement), and the like. The substantially omnidirectional pattern of the dipoles 72 and 92 is likely to be affected by the presence of the conductive tower structure 104, so that the spacing 106 may be selected to trade off mechanical stress, electrical loading, propagation pattern effects, and the like. For example, a quarter-wave spacing 106 will tend to cause a portion of the signal to be reflected from the tower 104 in such a way as to reinforce along an axis from the tower toward the antenna 70, promoting pattern asymmetry; a half-wave spacing 106 will tend to reinforce roughly at right angles to that axis; and other spacings will tend to reinforce at various other angles. Energy distribution with elevation as a function of azimuth is likewise affected by spacing 106.

The structure of FIG. 10 may be further modified in some embodiments, for example by placing the conductors (dipoles 72 and 92) within the structural framework of an RF-transparent tower 104, built for example from fiber-reinforced plastic or another suitable material. In such an embodiment, mechanical stress can be reduced and propagation symmetry is potentially increased. A triaxial lowest monopole 100 can allow the lower dipole 92 to be bottom fed while the upper dipole 72 is passive, reversing the arrangement (and the beam tilt compensation) of the embodiment described above. Such an embodiment can be positioned at the top of a tower instead of along the side of a tower. Weight and wind loading considerations may need to be thoroughly evaluated, as these factors are likely to be more significant for a top-mounted embodiment. Such an antenna may be free-standing (unguyed, base-mounted atop a tower), and may be enclosed in a radome rather than suspended within a braced open-work structure. In many embodiments, power will need to be delivered to a top-mounted obstruction light assembly without appreciably interfering with broadcast characteristics; various known and future lighting technologies may be suitable for that function.

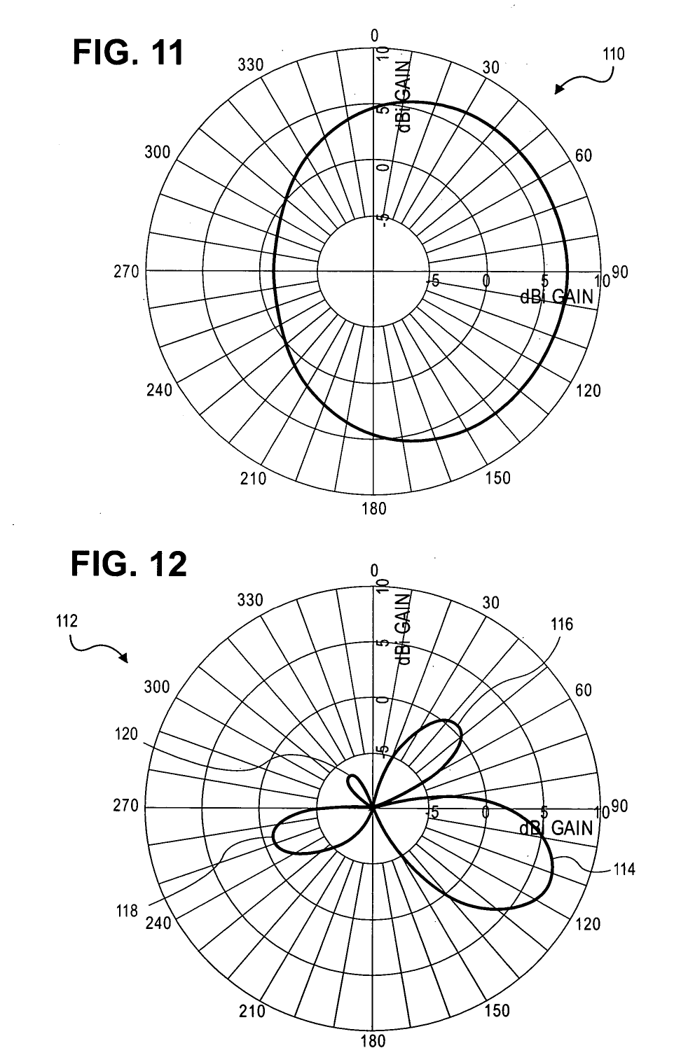

FIGS. 11 and 12 present calculated signal strength for a representative antenna according to FIG. 10, mounted using brackets alongside a metallic (reflective) tower. Peak signal strength 110 versus azimuth is shown in FIG. 12, while signal strength 112 versus elevation for an azimuth angle of interest is shown in FIG. 12, namely azimuth 90 degrees as shown in FIG. 11, for the antenna of FIG. 10. For reference, the 90 degree azimuth of FIG. 11 is to the right in FIG. 10 (zero into the page, 180 degrees to the left, and 270 degrees out of the page). The primary lobe 114 of FIG. 12 is below the horizon for signal strength above +2 dBi; the second lobe 116 is below +1 dBi entirely and is below −3 dBi for all elevations below +30 degrees, while the third lobe 118 is altogether below the horizon and the fourth lobe 120 is essentially nonexistent. As shown in FIG. 11, azimuth uniformity is within 3 dB over a 180 degree range, decreasing smoothly to −8 dB behind the tower structure 104 of FIG. 10. Alteration of dimensions in FIG. 10, as described above, can alter the attenuation due to the tower 104 and the relative strength of the lobes 114, 116, 118, and 120 in FIG. 12. Adding a second radiating assembly to the antenna of FIG. 10 on the opposite side of the tower from the one shown would provide a closer approximation of omnidirectional radiation at a penalty of roughly doubling weight, wind loading, transmitter power, and material cost.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A sky wave suppressing broadcast antenna system for short wave radio frequency electromagnetic (RF) signals, comprising:
a first radiator, configured to emit an RF signal with generally omnidirectional distribution of energy with respect to azimuth; and
a signal directing apparatus configured to direct energy from the first radiator, wherein the energy directed by the signal directing apparatus is energy that would support ionospheric reflective/refractive propagation, wherein the directed energy is so directed as to reinforce line-of-sight propagation.

2. The antenna system of claim 1, wherein the signal directing apparatus comprises a reflector positioned further from a mean terrain surface than the first radiator.

3. The antenna system of claim 2, wherein the reflector further comprises:
a reflector surface, configured to substantially reflect electromagnetic radiation, wherein the surface reflects radiation at least in part over a range of frequencies that includes at least the frequencies for which the antenna system is specified to operate;
a reflector structure, configured to support the reflector surface, further configured to maintain the reflector surface in a substantially invariant shape with respect to the first radiator; and
a reflector mount, configured to establish a stable spatial configuration between the reflector structure and the first radiator.

4. The antenna system of claim 3, wherein the reflector further comprises:
a reflector shape, electrically equivalent to a frustum of a cone over the specified frequency range, wherein a larger edge boundary of the shape is located closer to a nearest terrain surface than a smaller edge boundary of the shape, wherein the smaller edge boundary is adapted to promote attachment to the reflector mount; and
a plurality of reflector components collectively forming the reflector shape, wherein dimensions, positions, interconnections, and materials of the components establish reflectivity to a selected extent over the specified frequency range.

5. The antenna system of claim 2, wherein the antenna system further comprises a spatial interrelation between the first radiator and the reflector, wherein energy emitted directly from the first radiator and directed toward or below a horizon line providing a limit for the mean terrain surface with respect to a locus of elevated mechanical attachment of the first radiator mount, propagates at least in part without impediment, wherein energy emitted from the first radiator and directed into a spatial region above the horizon line, and capable of sky wave propagation under at least some atmospheric conditions, is reflected at least in part, wherein the reflected energy is directed not higher than the horizon line at least in part, and wherein the reflected energy additively reinforces the direct energy at least in part.

6. The antenna system of claim 2, further comprising:
at least one radiating element comprising the first radiator; and
provision for attachment of the at least one radiating element to an elevated structure external to the antenna system, whereby the at least one radiating element is so positioned as to permit line of sight propagation of electromagnetic signals therefrom over a specified range of distances.

7. The antenna system of claim 1, wherein the signal directing apparatus comprises a driven radiator.

8. The antenna system of claim 7, wherein the driven radiator of the signal directing apparatus further comprises:
a second radiator, substantially electrically equivalent to the first radiator and collinear therewith, configured to emit RF energy comparable in magnitude and phase with the RF emission of the first radiator, wherein the second radiator is so positioned spatially with respect to the first radiator as to permit RF emission from the second radiator to destructively interfere with RF emission from the first radiator in a sky wave direction and to constructively interfere with radio emission from the first radiator in a terrestrial wave direction;
a power splitter configured to accept at least one broadcast signal input and to provide a plurality of broadcast signal outputs;
a plurality of impedance-matching RF signal couplers, whereby RF energy from the respective outputs of the power splitter is coupled to the monopoles of the respective dipoles of the first and second radiators with phase orientation that realizes the constructive and destructive interference indicated; and
a provision for mechanical attachment of the second radiator in an elevated location.

9. The antenna system of claim 1, wherein the signal directing apparatus comprises a parasitic radiator.

10. The antenna system of claim 9, wherein the first radiator further comprises:
at least one vertically-oriented active dipole, wherein the at least one active dipole is attached to and spaced away by a specified distance from a support structure that is external to the antenna system and that provides elevation therefor, and wherein active dipoles in any number thereof greater than one are distributed at a common elevation and at specified positions with respect to the support structure;
a power splitter, wherein, for any number of active dipoles greater than one, RF signal power to be applied to the first radiator is accepted as a power splitter input, is split into a plurality of signals equal in number to the number of active dipoles, and is provided to the respective active dipoles; and
at least one RF signal coupler, wherein RF signal power is coupled into the at least one active dipole proximal to a vertical center thereof, and wherein RF signal power is coupled into component monopoles of the at least one active dipole through at least one impedance matching network.

11. The antenna system of claim 9, wherein the parasitic radiator of the signal directing apparatus further comprises:
a second radiator, configured to couple and reradiate RF energy emitted by the first radiator, wherein the second radiator is so positioned with respect to the first radiator that RF emission from the second radiator destructively interferes with RF emission from the first radiator in a sky wave direction and constructively interferes with RF emission from the first radiator in a terrestrial wave direction; and
a provision for mechanical attachment of the second radiator in an elevated location.

12. The antenna system of claim 11, wherein the second radiator further comprises:
at least one vertically-oriented parasitic dipole, wherein the at least one parasitic dipole is attached to and spaced away by a specified distance from a support structure that is external to the antenna system and that provides elevation therefor, and wherein parasitic dipoles in any number thereof greater than one are distributed at specified positions with respect to the support structure; and
at least one intermonopole coupler, wherein the at least one coupler establishes electrical interconnection between proximal ends of respective monopoles of the at least one parasitic dipole.

13. A sky wave suppressing broadcast antenna system for short wave radio frequency electromagnetic (RF) signals, comprising:
means for radiating, configured to emit an RF signal with generally omnidirectional distribution of energy with respect to azimuth;
structural means for positioning the first means for radiating in an elevated location; and
means for directing signals, configured to direct energy from the first means for radiating, wherein the energy directed by the means for directing signals is energy that would support ionospheric reflective/refractive propagation, wherein the directed energy reinforces line-of-sight propagation below a horizon line as determined with respect to the first means for radiating.

14. The antenna system of claim 13, wherein a vertical reference axis of the antenna system structure is located proximal to a vertical centroidal axis of the means for structurally positioning, and wherein an azimuth plot of reflectivity of the means for structurally positioning includes a vertical axis of a centroid of reflection with respect to an impinging electromagnetic wave, wherein the impinging wave has a wavelength approximating a median transmission wavelength of the antenna, wherein the angle is stipulated with respect to the reference axis, wherein the centroid of reflection is established by calculation, test, or history, and wherein distribution of RF signal energy emitted by the antenna system differs from being omnidirectional with azimuth, further comprising:
means for applying, to a plurality of elements comprising the means for radiating, an RF power signal of magnitude that differs to a specified extent from element to element;
means for applying, to the plurality of elements, an RF power signal having a relative phase angle that differs to a specified extent from element to element; and
structural means for positioning the plurality of elements in individual orientations that differ to a specific extent from a uniform distribution of element position with reference to the vertical centroidal axis of the means for structurally positioning.

15. The antenna system of claim 13, wherein the means for radiating further comprises:
means for radiating vertically-polarized RF signals from a plurality of locations distributed at specified intervals around a tower, and at specified distances from the tower;
means for RF signal power splitting, wherein RF signal power to be radiated from a plurality of locations is split into a plurality of signals of comparable strength, and is distributed to the distributed plurality of locations of the first means for radiating; and
means for coupling RF signal power into the first means for radiating at the distributed plurality of locations.

16. The antenna system of claim 13, wherein the means for directing signals further comprises:
means for reflecting high-elevation-angle RF signal energy emitted by the first means for radiating, whereby such RF signal energy as is emitted above a specified elevation angle by the first means for radiating is redirected downward to an extent sufficient to substantially suppress sky wave signal formation; and
structural means for establishing a substantially fixed orientation between the means for reflecting and the first means for radiating.

17. The antenna system of claim 13, wherein:
means for radiating further comprises first means for radiating vertically-polarized RF signals from a vertical position with respect to a tower, wherein at least one radial spacing from the tower and at least one azimuthal orientation with respect to the tower are specified for the first means for radiating; and wherein
means for directing signals further comprises second means for radiating, so positioned with respect to the first means for radiating that RF emission from the second means for radiating destructively interferes with RF emission from the first means for radiating in a sky wave direction and constructively interferes with RF emission from the first means for radiating in a terrestrial wave direction, wherein the second means for radiating is excited by RF signals coupled parasitically from the first means for radiating; and
means for structural positioning of the second means for radiating in an elevated location.

18. A method for broadcasting short wave radio frequency electromagnetic (RF) signals, comprising the steps of:
providing on a broadcast tower a mounting point for an RF signal radiator, wherein the mounting point has sufficient height above mean terrain to permit line-of-sight transmission of high-band short wave RF signals over a specified area;
emitting a vertically-polarized RF signal from an active radiator having a specified distribution of energy with respect to azimuth, wherein the active radiator is affixed to the broadcast tower using the mounting provision; and
directing the RF signal energy in such fashion as to suppress sky wave propagation and to reinforce line-of-sight propagation over the specified area.

19. The method of claim 18, wherein directing the RF signal energy further comprises reflecting high-angle RF signal energy from the active radiator, whereby such RF signal energy as is emitted above a specified angle is redirected downward to an extent sufficient to substantially suppress sky wave signal formation.

20. The method of claim 18, wherein directing the RF signal energy further comprises absorbing and reradiating RF signal energy from the active radiator by a parasitic radiator, whereby RF signal energy emission above a specified elevation angle is substantially canceled by destructive interference to an extent sufficient to substantially suppress sky wave signal formation.
